(19) United States
(12) Patent Application Publication
(10) Pub. No.: US 2026/0099676 A1
(43) Pub. Date: Apr. 9, 2026

(54) ENHANCED ARTIFICIAL INTELLIGENCE VIRTUAL ASSISTANTS

(71) Applicant: Zoom Video Communications, Inc., San Jose, CA (US)

(72) Inventors: Madison Kay Holbrook, Ridgefield, WA (US); Juhua Ma, Los Gatos, CA (US); Stephen George Newton, San Jose, CA (US); Yuangang Tu, Kirkland, WA (US); Baoyuan Wang, Sammamish, WA (US)

(73) Assignee: Zoom Video Communications, Inc., San Jose, CA (US)

(21) Appl. No.: 18/908,096

(22) Filed: Oct. 7, 2024

(51) Int. Cl. G06F 40/30; G06F 40/40; G06N 3/0475

(52) U.S. Cl. CPC G06F 40/30; G06F 40/40; G06N 3/0475

(57) ABSTRACT

One example method for enhanced AI virtual assistants includes receiving, by an artificial intelligence (“AI”) assistant from client software executed by a client device associated with a user, a user request; determining an intent based on the user request; determining a user context or an operational context associated with the user request; obtaining short-term context information based on the user request; identifying one or more services based on the intent; invoking the one or more services based on the user request, the operational context, and the obtained short-term context information; and generating and providing a response to the user request based on an output from the one or more services.

### FIELD

The present application generally relates to artificial intelligence (“AI”)-based virtual assistants and more particularly relates to enhanced AI virtual assistants.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for enhanced AI virtual assistants;

FIGS. 3A-3C show an example system for enhanced AI virtual assistants;

FIGS. 4A-B and 5 show example graphical user interfaces for enhanced AI virtual assistants;

FIG. 6 shows an example method for enhanced AI virtual assistants; and

FIG. 7 shows an example computing device suitable for use with example systems and methods for enhanced AI virtual assistants.

### DETAILED DESCRIPTION

Examples are described herein in the context of enhanced artificial intelligence assistants. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

During a typical day, a user may need to perform any number of tasks; however, for some tasks, they may lack the time or the expertise to quickly address them. Thus, the user may seek assistance with those tasks from an artificial intelligence (“AI”)-based virtual assistant. An AI virtual assistant may be programmed to receive a text input from the user, interpret that input to identify one or more actions to perform, and a result to provide to the user. To enable the AI virtual assistant to effectively understand and handle a request from the user, an AI virtual assistant may be designed to include a task coordinator function that coordinates actions of a query processor, a large language model (“LLM”), one or more identified tasks, available functionality to address particular tasks, and interfaces to those functionalities. It may also track the completion status of various tasks and, when complete, respond to the user about the result.

However, while AI virtual assistants can be very powerful tools, they suffer from a lack of understanding about the relevant context when handling user requests. For example, if a user is in the middle of a meeting and the phone rings, she may instruct her AI virtual assistant to “tell him I will call him back.” However, the AI virtual assistant will not understand who “him” refers to and may either respond to the user asking for more information about who the user is referring to. This increases the amount of time spent interacting with the AI virtual assistant, but it also increases the computational workload because it requires multiple prompts and responses to be exchanged between the user and the AI virtual assistant. Thus, an example AI virtual assistant may include functionality to gather contextual information about the user, the user's current operational context, and other contextual information that may have accumulated over time and maintained in short-or long-term memory by the AI virtual assistant.

In one example, a user may type a request into a prompt area of a graphical user interface (“GUI”) of a client application for the AI virtual assistant to handle. The AI virtual assistant may receive the request and then gather contextual information about the user, such as from a user profile accessible by the client application, operational context about the client application itself, such as what kind of activity the user is engaged in, e.g., a chat channel, a video conference, or a phone call. The AI virtual assistant may then access a short-term memory to obtain additional context information about recently attend meetings, recent phone calls, recent email messages, recent chat messages, and so forth. How recent qualifies as “recently” is configurable, but may be within the last three days or a predetermined number, such as the last N meetings. Information stored in the short-term memory may be a particular meeting transcript itself, one or more emails, and so forth, or it may include links to such information, such as the name of one or more chat channels, a reference to one or more meeting transcripts, etc. Information qualifying for storage in the short-term memory may be rotated out of short-term memory after it no longer satisfies any preconfigured limits on the short-term memory. If long-term memory is needed, one or more searches may be performed for relevant information, such as past meeting transcripts, people connected to the user in a social relevancy graph, or other available information.

After obtaining context information from short-or long-term memory, the AI virtual assistant may communicate with an LLM to obtain information about the user's request, such as one or more tasks to perform, based on the contextual information that was gathered from the short-or long-term memory as well as the user context information and the operational context information. The LLM responds with the tasks based on the user request and the provided context information, the order in which the tasks must be performed, and whether any additional information is needed from the user. Once the tasks have been identified and ordered, the coordinator obtains information about available service functionalities that can be employed to obtain data, perform processing, or generate output as needed by the tasks. The information includes a written description about the capabilities of each of the service functionalities.

For each task, the LLM is provided the task and the descriptions of the available service functionalities to determine which service functionality (or functionalities) should be employed to perform the task. The LLM then responds with the identified service functionality as well as any other information needed to perform the task. The coordinator then allows the task to interface with the identified service functionality, such as through an application programming interface (“API”) or a messaging interface.

The service functionalities may be any suitable functionality that may be needed. For example, service functionalities may provide data storage, such as a database or cloud storage, to obtain information needed for the task, or it may include scheduling functionality to setup a meeting, or it may include email functionality to start a new email. Thus, when a service functionality is identified for a task as providing the needed functionality, the task can interact with the service functionality to provide the necessary information to the service functionality to allow it to perform its operations.

The coordinator ensures that the different tasks operate in the correct sequence. As each task completes, the coordinator updates its own records on the remaining tasks and initiates the next task or tasks to be performed. Once all of the tasks have completed, the coordinator initiates a response generator to create an output for the user based on their task. The response depends on the nature of the original task requested. Some tasks may request information or the answer to a question. In such a case, the response generator obtains information from the tasks and employs the LLM to generate a response using the obtained information as well as some or all of the context information initially provided to the LLM with the user request. Some tasks involve taking one or more actions, such as searching for information, scheduling a meeting, or drafting an email. Thus, the response generation may provide the requested information or a draft meeting invitation or email message. Still other kinds of tasks may involve other actions or responses. The response generator, after generating the response, provides it to the user and the task is completed.

Such an AI virtual assistant may provide enhanced capabilities of responding to user tasks or questions because it is able to obtain relevant context information for a user request, identify tasks that may be performed based on the user request and context information, whether in sequence or in parallel, to obtain information or execute actions, needed as a part of handling the request. Thus, the system is able to systematically deconstruct the task into individual components that can be handled by service functionalities available to the user, and ultimately generate the output(s) or action(s) required by the user's original input and based on relevant contextual information, thereby improving the effectiveness of the AI virtual assistant.

Zoom's goal is to invest in AI-driven innovation that enhances user experience and productivity while prioritizing trust, safety, and privacy. In August, Zoom shared that it does not use any customer audio, video, chat, screen-sharing, attachments, or other communications-like customer content (such as poll results, whiteboards, or reactions) to train Zoom's or third-party artificial intelligence models. Additionally, AI Companion is turned off by default—account owners and administrators control whether to enable these AI features for their accounts. Zoom provides admins and users control and visibility when AI features are being used or activated. By putting its customers'privacy needs first, Zoom is taking a leadership position, enabling its customers to use AI Companion and its capabilities with confidence.

This illustrative example is given to introduce the reader to the general subject matter discussed herein and the disclosure is not limited to this example. The following sections describe various additional non-limiting examples and examples of enhanced artificial intelligence assistants.

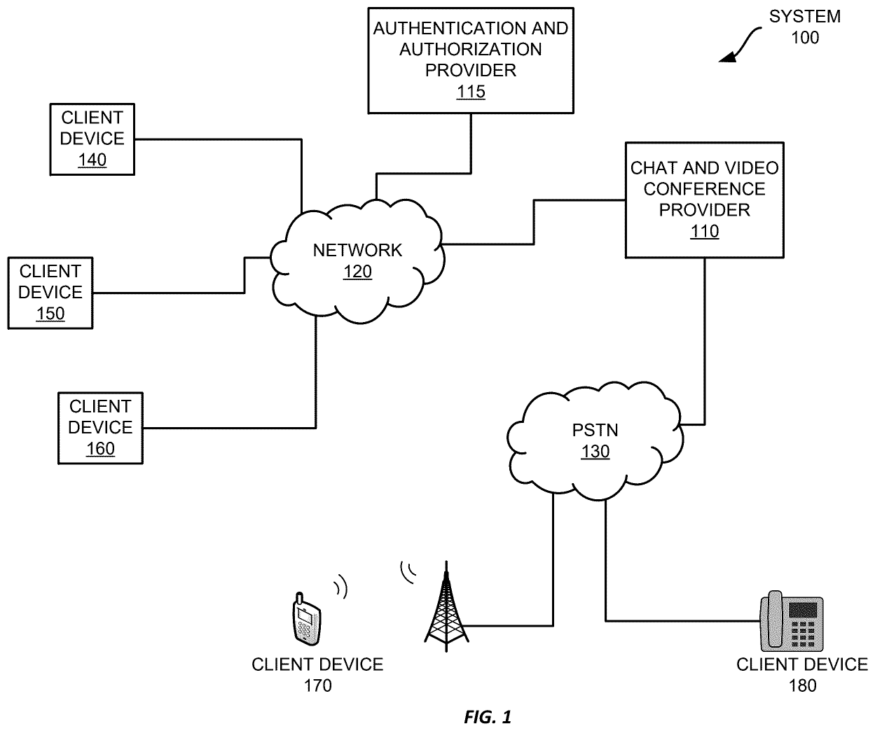

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

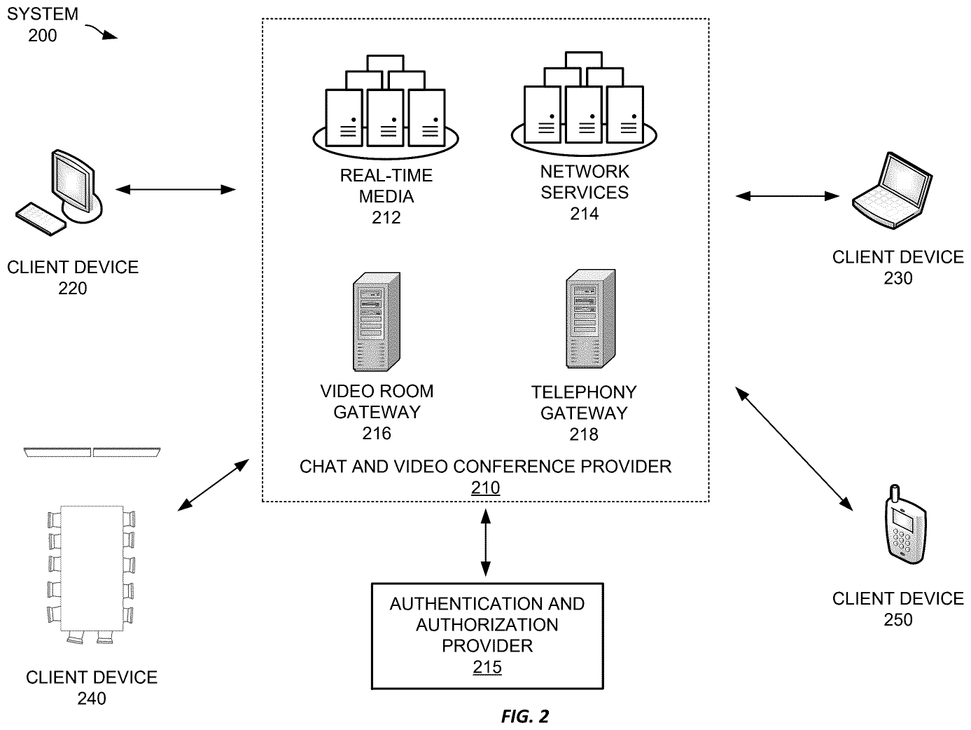

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices'participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

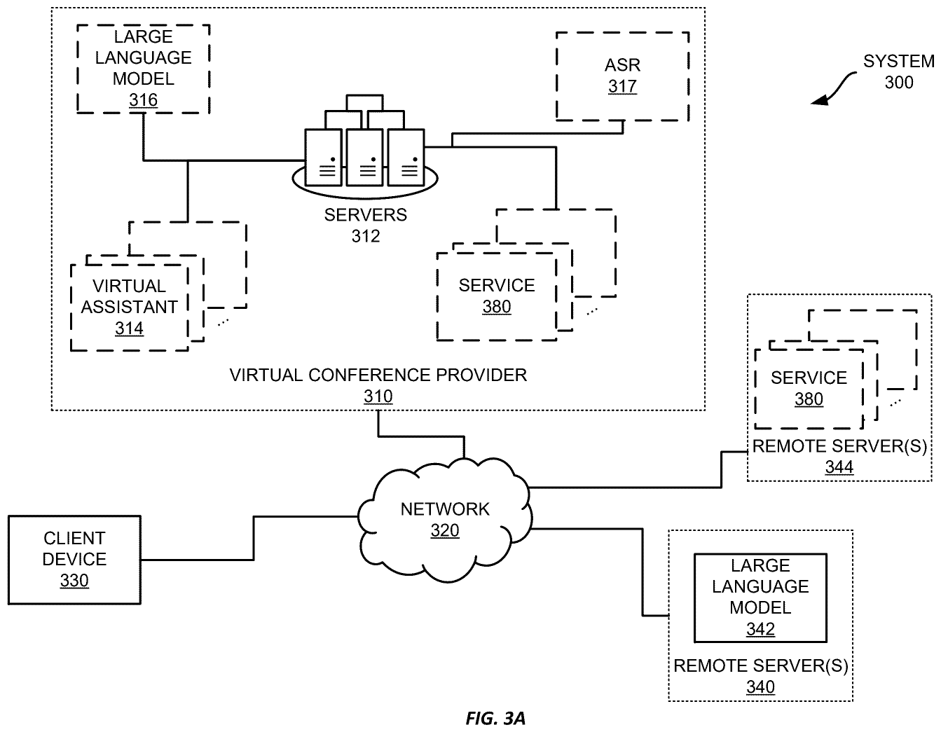

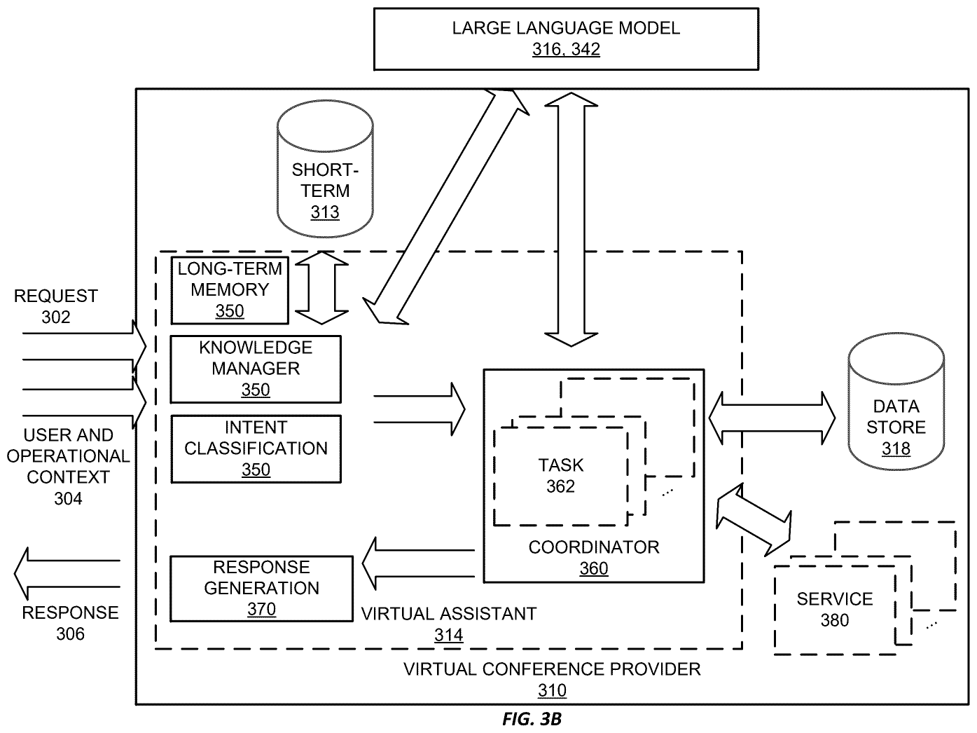

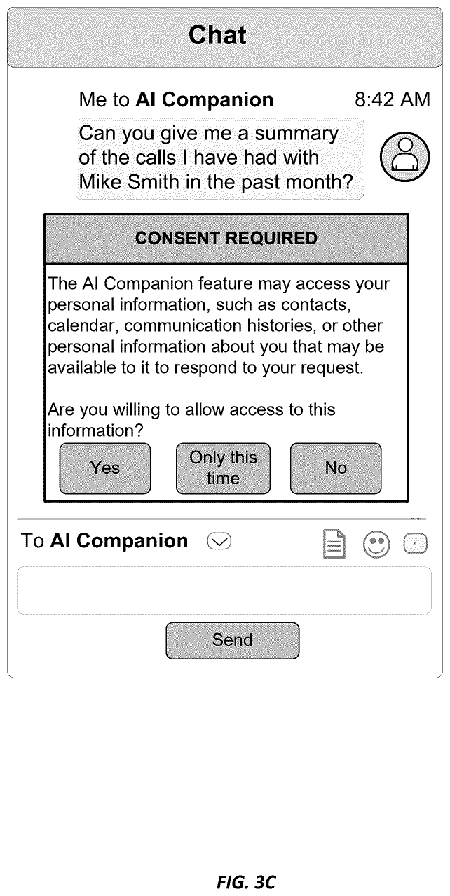

Referring now to FIGS. 3A-3B, FIG. 3A shows an example system 300 for enhanced AI virtual assistants. In this example, the system 300 includes a client device 330, a virtual conference provider 310, one or more remote servers 340 that host a LLM 342, and one or more remote servers 344 that host services that may invoked by an AI virtual assistant 314. In this example, the virtual conference provider 310 provides virtual conferencing capabilities, such as discussed above with respect to FIGS. 1-2, but also provides one or more servers 312 that provide AI virtual assistants 314 that may be allocated to requests received from users via their respective client device, such as client device 330, and one or more services 380 that may be invoked by the AI virtual assistants 314. In addition, the virtual conference provider 310 maintains its own LLM 310 that may be employed by a virtual assistant 314 instead of (or in addition to) the LLM 342 hosted by the remote server 340.

To obtain assistance from an AI virtual assistant 314, a user of the client device 330 may interact with the AI virtual assistant 314 via a web page or client application and request assistance by typing in or speaking a request for the AI virtual assistant 314 to perform. An example of such an interaction is shown in FIG. 3C.

As can be seen in FIG. 3C, a user has engaged in a chat session and has selected the AI Companion virtual assistant as the recipient of the request. The user has then entered a request for the virtual assistant to provide “a summary of the calls I have had with Mike Smith in the past month.” After entering the request, but before it has been provided to the AI virtual assistant 314, the GUI has displayed a consent authorization for the user to interact with. The consent authorization informs the user that their request may involve the AI virtual assistant 314 accessing multiple different types of information, which may be personal to the user. The user can then decide whether to grant permission to the AI virtual assistant 314 generally or only for this request. Alternatively, the user can decline to provide permission, which may prevent the AI virtual assistant from accessing the user's personal information.

Referring again to FIG. 3A, requests may be questions or requests for information, instructions to perform one or more actions, or a combination of these. In examples that allow requests to be spoken, the client device or the virtual conference provider may provide automatic speech recognition (“ASR”) 317 to convert the spoken request into text that can be received and processed by the AI virtual assistant. In some examples, the AI virtual assistant 314 may provide such ASR functionality, though other examples may employ ASR 317 to generate a textual representation of the request that is then passed to the AI virtual assistant 314.

The AI virtual assistant 314 receives a request from the client device 330 and determines context information to employ when handling the request and also determines the user's intent based on the request.

To assist with handling the user request in this example, the AI virtual assistant obtains different kinds of context information, including user context information, operational context information, and short- and long-term context information. For example, the AI virtual assistant 314 may obtain user context information from the virtual conference provider 310, such as from a user profile or user account. User context information may be obtained from other sources, such as the user's own client device 330, relationship graphs maintained by the virtual conference provider or other service provider, social media sites, email inboxes, chat channels, or other stores of information about the user, their preferences, their interests, or their relationships. In some examples, the user may manually identify within their profile particular information as being important, such as one or more VIPs (very important person, e.g., the user's supervisor, executives at the user's employer, or other important people in the user's personal or professional life), one or more topics, one or more chat channels, one or more groups of people, or one or more organizations. Any other information may be included in the user's profile, including personal information such as their location, profile picture, or biographical information.

In addition to obtaining user context information, the AI virtual assistant may obtain operational context information, such as the state of a client application in use by the user at the client device 330, whether the user is engaged in a communication session, such as a meeting, phone call, or chat session (whether in a chat channel or in direct messages with another person), information about participants in such a communication session, information about applications associated with such a communication (e.g., a screen share of a slide presentation or document or an app launched within the client application to provide additional functionality during the communication session), information about an email that is active or otherwise selected within the client application, the user's schedule, the date and time, the day of the week, or other information about the operational state of the client device 330 or an associated device such as an IP phone, camera, or microphone. Operational context may also indicate the current state of the client application, such as which view or tab is in the foreground, whether the user selected a particular GUI option, such as a button within the GUI, what panels may be visible, and so forth.

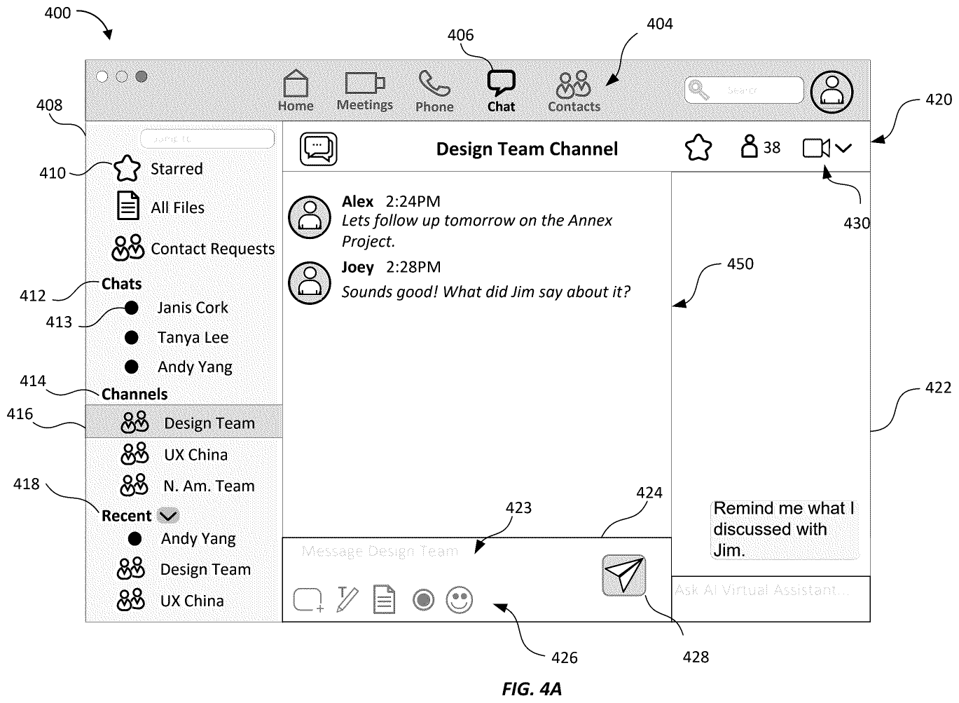

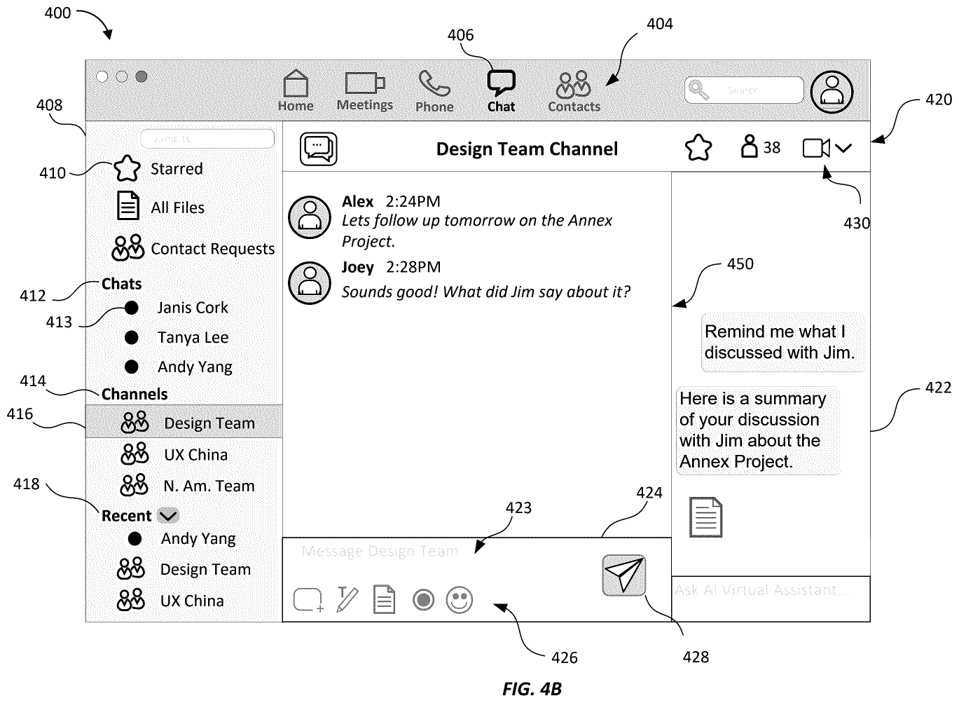

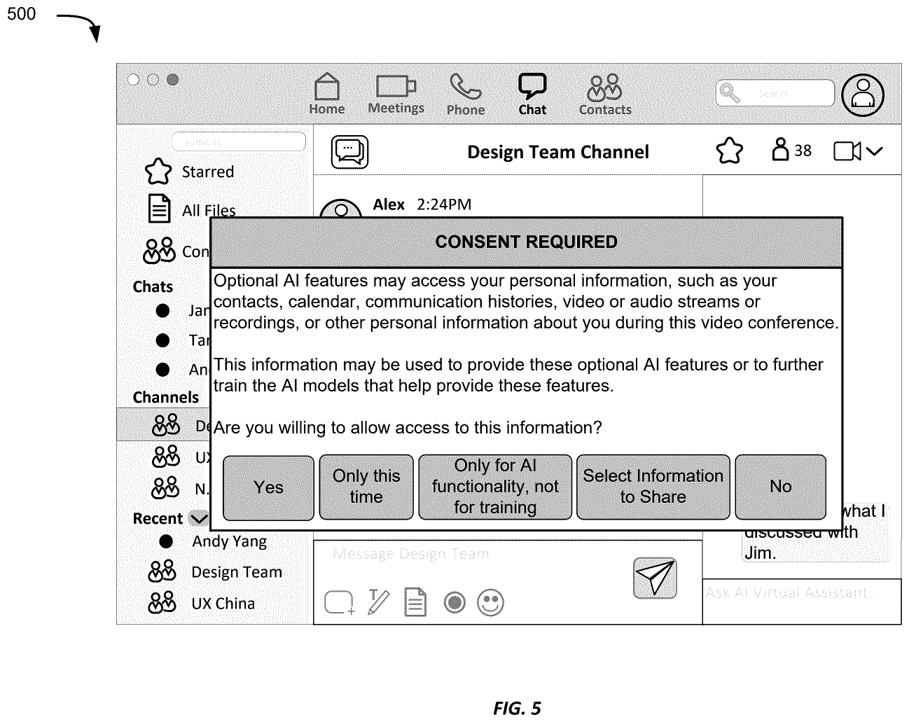

Referring to FIG. 4A, FIG. 4A shows an example GUI 400 for a client application that includes a AI panel 422 to interact with the AI virtual assistant 314. The GUI 400 may include a general dashboard 404, which allows the user to select different available functionalities provided by the client application. In this example, the user has selected the chat functionality 406, but other functionality includes meetings, phone, and the users contacts. Still other options may be available in some examples, such as integrated apps, a virtual whiteboard, or a notepad. Because the user has selected the chat functionality, they have been presented with a chat-based GUI that includes a chat control dashboard 420, a sidebar 408, a chat window 450, a reply dashboard 426, and a reply panel 424.

In this view, the chat window 450, the reply panel 424, and other components illustrated in FIG. 4A may be displayed on the client device. In other examples, a contacts button may be selected by a user. In response the contacts button being selected, the chat window 450, the reply dashboard 426 and the reply panel 424 may be replaced by a display of a contacts window including a list of user contacts associated with the user of the client device. The sidebar 408 may be displayed alongside the contacts window. Other configurations are also possible. Various buttons on the general dashboard 404 may correspond to various displays of windows being displayed on the client device. Any number of components shown in FIG. 4A may be displayed on the client device with any of the various windows. Similarly, any of the components may cease to be displayed in accordance with any of the windows.

If the user interacts with the AI virtual assistant 314 via the GUI 400, operational context information can include which functionality the user is using or which tab is active in a client application (chat, in this example), which chat channel they are interacting with or have recently interacted with, which other users are active or have been active recently in that chat channel, what other chat channels the user is a member of, what information is represented in the “Starred” feature 410 of the client application. If the user interacts with the AI virtual assistant via the AI panel 422, the operational context may indicate that interaction, as opposed to selecting an option in the GUI that may trigger an AI virtual assistant request. For example, if the user selects the dropdown option 430 to begin a video chat, it may send a request to the AI assistant to schedule a video chat and indicate that the request was initiated by selecting the dropdown option 430. The AI assistant may then receive operational context information indicating potential people that the user wishes to chat with.

In this example, the user has asked the AI virtual assistant 314 to “Remind me what I discussed with Jim.” The AI virtual assistant 314 may also receive user context based on the user's user profile as well as operational context, which indicates that the user is active in the Design Team chat channel and that Alex and Joey are also present in the design team channel. The most recent chat messages may be stored in short-term memory as short-term context (discussed below) and be obtained by the AI virtual assistant and may help focus the AI virtual assistant on the Annex Project, which was being discussed in the Design Team channel.

Referring again to FIG. 3A, the AI virtual assistant 314 may also access short-term or long-term memories from which additional contextual information may be obtained, which are described in greater detail below. Short-term memory may provide information about recent or upcoming events, meetings, chat discussions, and so forth, while the long-term memory may provide search capabilities across a wide range of data available to the AI virtual assistant.

In addition to obtaining the context information, the AI virtual assistant 314 also determines the user's intent as reflected in the user request 302. The intent may be one or more tasks that the user wishes to invoke that may be ascertained from the request. For example, if the user issues a request to “Help me prepare for my meeting,” the intent may be determined as needing to identify the correct upcoming meeting, search for relevant information, and summarize that information for the user.

To determine the user's intent, the AI virtual assistant can use different techniques, such as generating an embedding based on the user's request and identify related services that are similar to the information contained in the user's request, as will be discussed in greater detail with respect to FIG. 3B. In some examples the AI virtual assistant interacts with an LLM 316, 342 to identify and break the request down into tasks that can be individually processed, identify the order of operation for the tasks, and identify additional information that is needed from the client device 330. Each of the tasks may invoke one or more services 380, either locally provided by the virtual conference provider 310 or by one or more remote servers, e.g., remote server(s) 344, to take actions or obtain information as a part of the AI virtual assistant handing the request. The tasks are ordered and coordinated by coordinator functionality that receives ordering information from the LLM 316, 342. The coordinator can also aggregate the information received from the tasks as they operate and provide the information to response generation functionality that can generate a final response to the client device once the request has been completed.

The services 380 may include any number of functionalities that may be provided by the virtual conference provider 310 or remote servers 344. For example, a request may be to setup a meeting with another person. Tasks generated for the request may include identifying contact information for the person, determining free times on their calendar, generating a virtual conference meeting identifier and passcode, and generating a meeting agenda and invitation. Thus, the services 380 involved may include an employee directory or email directory service, a calendar service, a virtual conference service, and an LLM (e.g., LLM 316, 342) to generate a title and agenda for the meeting. Other suitable services may include document management systems, search engines, support ticket systems, telephone systems, chat systems, or music or video playback systems. However, any suitable service may be employed according to different examples.

By employing a LLM to help break down the request received from the client device, and by using the LLM to assist with executing the requests, the AI virtual assistant can 314 efficiently and accurately handle requests on behalf of various users. In addition, the use of an LLM allows the user to provide a natural language description of a request to be performed and to interact with the AI virtual assistant in an intuitive manner to obtain the desired result.

Referring now to FIG. 3B, FIG. 3B illustrates a more detailed view of the virtual conference provider 310 depicted in FIG. 3A. The virtual conference provider 310 includes an AI virtual assistant 314 that includes intent classification 350 functionality, a coordinator that can coordinate the execution of one or more tasks 362, and response generation functionality 370 that can generate a response 306 to a user after completion of a request 302. As discussed above, the virtual conference provider 310 also provides one or more services 380 that may be invoked to perform one or more tasks 362. In addition, the virtual conference provider 310 includes a data store 318 that includes information about the available services at the virtual conference provider 310.

To use the AI virtual assistant 314, a user submits a request 302 to the AI virtual assistant 314 via a client application executed by their client device 330. The AI virtual assistant 314 then obtains user and operational context 304. As discussed above with respect to FIG. 3A, the user and operational context 304 may be obtained from various sources. For example, user context may be obtained from a user profile maintained by the virtual conference provider 310 or it may be requested from the user's client device 330, e.g., from the client application, which may have access to the user's profile. Thus, the AI virtual assistant 310 may transmit a request to the virtual conference provider 310 or the user's client device for the user's profile. However, it should be understood that a user profile may be maintained by any third party. Operational context, as discussed above with respect to FIG. 3A, may be similarly requested from the user's client device, such as by transmitting a message to the user's client application and receiving operational context in response. In some cases, the operational context may be automatically included with the user's request, such as via metadata accompanying the user request 302.

In addition, the AI virtual assistant 314 may obtain additional context information from short-term or long-term memory 313, 315. In this example, the short- and long-term memories 313, 315 are maintained by the virtual conference provider 310, however, they may be stored at any suitable location, including the user's client device 330 or another remote server 340, 344.

For example, a short-term memory 313 may maintain information about the user's recent or near-term upcoming activity, such as recent meetings, phone calls, emails, chat messages, deadlines, or other activities, or upcoming meetings, phone calls, deadlines, or other activities. Examples of activities may be upcoming trips (business or pleasure), sporting events, social events, or conferences. The extent of “recent” and “near-term” throughout this disclosure can be configured by the user or an administrator to extend for a predetermined threshold, such as for a period of time, e.g., a week, or for a predetermined number of events, e.g., most recent fifty emails or chat messages. The specific configuration may vary from user to user, but may be used to help identify relevant contextual clues when using pronouns or other references in a request that otherwise lack an antecedent. For example, if a user submits a request asking the AI virtual assistant to “remind me what I discussed with Jim,” as shown in FIG. 4A the AI virtual assistant can access the short-term memory to obtain context information that may indicate a recent conversation or meeting with someone named Jim. For example, the short-term context information, which has been updated with the recent chat messages in the Design Team chat channel provides short-term context information for the request, such as the name of a relevant project and other people participating in the discussion. Other types of ambiguities may similarly be resolved by obtaining various types of context information that can be used in conjunction with a user's request to effectively respond to it.

And while the user's own context information, their operational context, or contextual information stored in short-term memory may provide the most relevant context for some requests, other requests may require additional contextual information. Thus, the AI virtual assistant may also access a long-term memory 315 to obtain context information from other sources that may be available. While a short-term memory 313 may store certain information according to the predetermined thresholds discussed above, the long-term memory 315 provides search capabilities to access any other data sources that may be accessible to help determine relevant context. For example, the long-term memory 315 may obtain information from a searchable relevancy graph. A relevancy graph may be maintained that represents different entities (e.g., people or resources) with nodes within the graph and a strength of a connection between two entities by a weight on an edge connecting nodes representing the two entities. A relevancy graph may be used to identify other people connected to the user, such as with a threshold connection strength, rather than just those they have recently communicated with (as indicated by the short-term memory). The long term memory may also provide search functionality to allow the AI assistant to search for potentially relevant contextual information, such as the user's calendar, email, chat histories, contacts, and so forth. While some information related to these may be stored in the short-term memory, the long-term memory may be used to perform a more comprehensive search based on the user's request. Thus, the long-term memory may provide additional contextual information that may be relevant to any particular request that is not available in the short-term memory.

In this example, when a request 302 is received from a remote client device, e.g., client device 330, and after the user and operational context information 304 has been received, the AI virtual assistant 350 performs multiple functionalities in parallel: it determines the user intent, using the intent classification functionality 350, it uses the knowledge manager 352 to obtain context information from the short-term memory 313, and may also obtain additional context from the long-term memory.

To determine the user's intent, the intent classification functionality 350 may generate an embedding based on the user's request 302 and generate embeddings based on descriptions of the services 380 available to the AI virtual assistant 314 stored in the data store 318. To do so, the intent classification functionality 350 employs a trained ML model, such as a trained autoencoder, a trained predictor model, or any other variety of trained neural network, to generate binary embeddings for the user request 302 and for descriptions of the available services stored in the data store 318. The binary embeddings may be generated based on the entirety of the user request 302 or service descriptions, or multiple embeddings may be generated for each based on individual words, phrases, sentences, or other portions of the user request 302 or service descriptions. The binary embeddings are then used to select one or more relevant services 380. In this example, the intent classification functionality 350 analyzes each service description embedding against the user query embedding to determine a similarity score for the embeddings. If the similarity score satisfies a predetermined threshold, the service is determined to be related to the user query. Otherwise, the service is determined to be not related to the user query. Through this process, relevant services 380 are selected.

While the example shown in FIG. 3B can employ binary embeddings, other techniques may be used to determine relationships between the user request 302 and one or more services 380. For example, rather than generating binary embeddings using a trained ML model 345, as discussed above, a cross-encoder may be provided with textual inputs representing the user request 302 and service descriptions. The cross-encoder compares the two textual inputs to determine a similarity between them and outputs a score or confidence indicating the level of similarity, e.g., a value between 0 and 1. Thus, the service selection functionality 350 could employ such a technique to identify services that are sufficiently related to the user query, e.g., the score satisfies a threshold such as 80% or 90%. After analyzing each service description with respect to the user request 302, a set of related services can be generated. And while these techniques represent some ways to determine relevancy for services, others may be used. For example, the intent classification functionality may employ an LLM to determine the relevance of one or more services 380 to the user request 302.

In addition, the knowledge manager obtains available contextual information from the short-term memory 313 and submits a prompt to the LLM 316, 342 to determine whether sufficient contextual information was available in the short-term memory to respond to the request. For example, the AI virtual assistant 314 may generate a prompt, such as “The user has submitted this request: [Request]. The following context is available to interpret the request. Is this enough context to respond to the request?” If the LLM 316 responds that sufficient context has been provided, the request transformation 350 functionality may begin processing the request. Otherwise, the AI virtual assistant 314 may obtain additional context information from the long-term memory 315. In some examples, to help narrow the scope of the context information available in the long-term memory, the AI virtual assistant may generate an additional prompt to the LLM, such as “The user has submitted this request: [Request]. The following context is available to interpret the request. What additional kind of context is needed?” The response from the LLM may then be used to search the available information in the long-term memory based on the kind of contextual information identified by the LLM. For example, if the LLM indicates that meeting information is needed, the AI virtual assistant 314 may only search for meeting information. However, if the LLM indicates that people related to the user need to be identified, the knowledge manager may initiate a search of a relevancy graph to identify people with connections to the user.

It should be appreciated that in some examples, not all of the context information discussed above may be available for a particular request. For example, a user may not have created a user profile or may not have logged into their account before submitting the request. Thus, user context information may not be available. Similarly, the client application used by the user may not be configured to provide operational context information to the AI assistant. Thus, the AI assistant will operate based on what sources of context information are available to it.

In some examples, after the AI virtual assistant has obtained sufficient context information, the AI virtual assistant may provide the request 302 and the obtained context information (user, operational, short-term, or long-term) to the LLM 316, 342 and prompt the LLM 316, 342 to break down the request into tasks 362, to provide an ordering for the tasks 362, and to identify additional information to be requested to perform the requested request 302. The request transformation functionality 350 may provide a series of text prompts to the LLM 316, 342 to invoke this functionality such as:
Prompt 1: I have a request that needs to be performed and I have some requirements for you about the request. Here is the request: [Request description]
Prompt 2: I also have the following context related to the request: [user, operational, short-term, or long-term context, as available]
Prompt 3: Please provide the tasks that need to be performed to accomplish this request
Prompt 4: Please identify the ordering of the tasks, including whether any task is not dependent on another task to complete.
Prompt 5: Please identify information that is not included in the request that may be needed to complete one or more of the tasks.

In response to the prompts, the LLM 316, 342 provides one or more tasks 362 to be performed, as well as the ordering of those tasks 362 and information from the request or context information that is needed to perform each task, and if any additional information is needed from the user.

If additional information is requested, the AI virtual assistant 314 may output a message to the user identifying the additional information that is needed. After receiving the information, the request transformation functionality may issue one or more additional prompts to the LLM 316, 342 that provides the additional information and requests any additional tasks 362 or further information that may be needed. This continues until no additional information is required from the user. For example, if the user sends a request to “Help me prepare for my meeting,” the AI virtual assistant 314 may issue the prompts identified above.

In addition, the AI virtual assistant 314 may also request additional information from the user, if the provided context information does not allow the LLM to fully process the request. For example, the LLM may respond that it does not have enough information and needs additional information about a particular topic. For example, to help the AI virtual assistant 314 identify relevant content to access and summarize, it may ask the user to identify which upcoming meeting the user needs to prepare for, if the context information indicates that there are several. The user may then respond, using natural language, to identify the specific meeting, or it may select one or more options from a GUI window. The AI virtual assistant may then construct an additional prompt to the LLM 316, 342 to identify the correct meeting.

After the tasks 362 have been identified, they are provided to the coordinator along with the ordering of the tasks 362. Some tasks 362 may be dependent on the completion of other tasks 362, and thus they must be executed in order. However, some tasks 362 may not be dependent on other tasks 362 and may be executed at any time, or in parallel with other tasks 362. Further, in some cases the LLM indicate that additional information is needed from the user, which the AI virtual assistant 314 may then communicate to the user, such as via the chat functionality shown in FIG. 3C. After obtaining the additional information, the AI virtual assistant 314 may provide the additional information to the LLM 314, 342, which may then identify one or more additional tasks.

For example, to assist the user with the summarization request requested above, the tasks may include obtaining chat logs from one or more chat channels, obtaining emails from the user's email system, obtaining meeting information from the user's calendar, obtaining transcripts for relevant meetings, and so forth.

To execute a task, the coordinator 360 accesses the data store 318 and obtains information about the available services 380. In this example and as discussed above, the data store 318 includes a directory of the available services 380 that includes a textual description of the capabilities of each service 380 as well as instructions regarding how to invoke those capabilities. For services hosted by remote servers 344, the coordinator 360 may request such information from the remote servers 344. The instructions regarding how to invoke service functionality may include a description of an API, one or more functions provided by the API and a description of what each function does and what information it needs and what information it outputs, or a format for a messaging interface or sequence of messages for one or more such functionalities. And while this example involves an API or messaging interface, other interfaces may be used as well, such as inter-process communication or a query interface for a database management system, such as structured query language (“SQL”).

In some cases, the LLM 316, 342 may also specify an order for one or more tasks or it may identify dependencies between tasks. For example, if five tasks are identified, the LLM 316, 342 may specify the order the tasks should be executed in and whether the output of one or more tasks should be used as an input to another task. For example, the LLM 316, 342 may identify five tasks and specify the order as being tasks one and two to be performed first, followed by task three, followed by task four that takes the output of tasks one and three as input, and finally task five that takes the output of tasks two and four as input. The coordinator 360 may obtain the sequencing information in addition to the identified tasks and use the sequencing information to execute the tasks in the proper sequence and with the appropriate inputs.

After obtaining the information about the available services 380, the coordinator 360 prompts the LLM 316, 342 by identifying a particular task 362 and the descriptions of the available services 380 to determine which service(s) should be invoked to handle the task 362. Based on the task and the descriptions of the available services 380, the LLM 316, 342 identifies one or more services that closely match the task and provides an identification of the service(s) to the coordinator 360. The LLM 316, 342 may also identify an interface, e.g., an application programming interface (“API”) or formatting for messages to be sent to the service, to perform the task. The coordinator 360 can then use the response from the LLM 316, 342 to invoke the appropriate service(s) 380, such as by calling the corresponding API or generating and sending one or more messages to the services 380, whether hosted by the virtual conference provider 310 or a remote server 344, to obtain information or perform an action. The coordinator 360 can then process each of the tasks 362 in a similar way according to the order defined by the LLM 316, 342. Further, in some examples, the LLM 316, 342 itself may perform the operation specified by the task 362, such as by directly interacting with an appropriate service or services according to the description of the services and instructions regarding how to invoke functionality of those services stored in the data store 318. For example, the LLM 316, 342 may generate and output a message or database command to a service 380 to obtain information from the service 380.

As the tasks 362 execute and complete, the coordinator 360 accumulates information about each completed task 362, such as information obtained or actions performed. For example, for the user's request for a summary of his conversations about Project X, the various tasks may provide one or more emails, chat logs, or meeting or phone call transcripts to the coordinator. The information may be provided to subsequent tasks 362 to use, such as a summarization task, or may be accumulated to use to generate a response to the user who initially submitted the request 302. If certain tasks depend on the completion of prior tasks, the coordinator 360 can determine whether a further task is ready to be performed based on a completion status of one or more other tasks. For example, in this example, a summary of the conversations needs the underlying conversations to be obtained first. Once any necessary prior tasks have been completed, the coordinator 360 can then execute the further task. Thus, after the coordinator has executed tasks to obtain the various conversation information, such as by invoking services 380 associated with one or more chat channels, an email inbox, and a transcript repository, the coordinator can then invoke the next task and provide the various conversation information as inputs. Thus, the coordinator 360 can employ the sequencing information

Once all of the tasks 362 have completed, the AI virtual assistant 314 invokes its response generation functionality 370 to generate a response to send to the user who submitted the request. In this example, the response generation functionality 370 provides one or more prompts to the LLM 370 to generate a suitable response to the user. For example, in the case of providing the summary, the LLM 316, 342 itself may generate the summary. The summary may then represent the final output to provide to the user, though the AI virtual assistant 314 employ the LLM to generate some responsive text, such as “Here is the summary you requested.” However, if the original request was to generate an email to another person, the response generation functionality 370 may provide a draft email body provided from a task along with the email address of the targeted person from a different task. It may then obtain a subject for the email from a third task, which may have generated the subject based on the draft email body. The response generation functionality 370 may then provide one or more prompts to the LLM 316, 342 to generate an email along with the outputs from the tasks and an indication of what each output represents, e.g., the email body, the email address, and the subject line. The LLM 316, 342 may then generate an email document according to a particular format, which may then be provided to the user as an email file along with a message indicating that the email has been created. Other examples may simply indicate that a requested action has been performed.

After the response 306 has been generated, it is transmitted to the remote client device 330 where it is displayed to the user. For example, the summary may be output to the GUI or it may be delivered in another format, if specified by the user, e.g., as a summary document. In some cases, a message may be output in the GUI indicating that the output has been generated, such as an summary requested by the user. If the output includes a file, it may be provided in the GUI such as shown in FIG. 4B.

Referring to FIG. 5, FIG. 5 shows a GUI 500 presenting a consent option to employ certain AI-assisted features. In some examples according to the present disclosure, a user may select an option to use one or more optional AI features available from the virtual conference provider, such as the enhanced AI virtual assistants as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 5, a user has sent a message to the AI virtual assistant. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

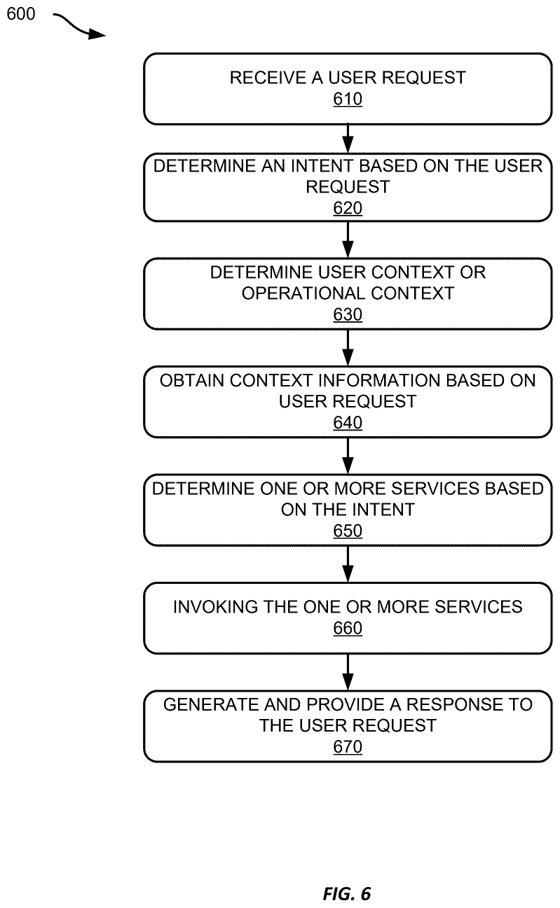

Referring now to FIG. 6, FIG. 6 shows an example method 600 for enhanced AI virtual assistants. The example method 600 will be described with respect to the example system shown in FIGS. 3A-3B; however, it should be appreciated that any suitable system according to this disclosure may be employed. Moreover, while the description of FIGS. 3A-3B is with respect to a virtual conference provider, any suitable service provider may be employed according to different examples.

At block 610, the AI virtual assistant 314 receives a user request 302. In this example, the user manually types a request into a panel 422 within a GUI 400 of a client application. In some examples, however, the user may speak a request into a microphone, which may be provided to the virtual conference provider 310. The spoken request may be provided to ASR functionality 317 to convert it into text, which is then provided to the AI virtual assistant as the user request. Further, in some examples, a user may select a GUI element to trigger certain functionality, such as a button to create a new meeting or a GUI element to prepare for an upcoming meeting. The selection may generate a user request to the AI virtual assistant.

At block 620, the AI virtual assistant 314 determines an intent based on the user request. As discussed above with respect to FIGS. 3A-3B indicates the actions the user wishes to be taken, which may then be used to select one or more services to invoke to handle the user request. As discussed above, the user intent may be determined based on embeddings generated from the user request and descriptions of one or more services 380 available to the AI virtual assistant. In some examples, a user intent may be determined by using a cross-encoder, which may be provided with textual inputs representing the user request 302 and service descriptions. The cross-encoder compares the two textual inputs to determine a similarity between them and outputs a score or confidence indicating the level of similarity. In further examples, the AI virtual assistant 314 may provide the user request to an LLM and prompt it to identify the user's intent or one or more tasks to perform.

At block 630, the AI virtual assistant 314 determines a user context or an operational context. As discussed above, the AI virtual assistant may access a user profile for the user maintained by the virtual conference provider 310 or other service provider to determine the user context. The AI virtual assistant may also obtain operational context information from the client application, generally as discussed above with respect to FIGS. 3A-3B. As discussed above, in some cases, user context or operational context may not be available (or neither may be available). Thus, at block 630, either user or operational context may be obtained, or if not available, block 630 may be omitted.

At block 640, the AI virtual assistant 314 obtains additional context information based on the user request. In this example, the AI virtual assistant 314 obtains context information from short-term memory 313. As discussed above, short-memory may store context information indicating one or more recent or upcoming meetings, one or more recent or upcoming events, one or more email messages that the user has recently received or interacted with, one or more chat channels the user has recently interacted with, one or more recent phone calls the user has participated in, and so forth. After receiving the user request 302, the AI virtual assistant may obtain a portion or all of the context information from the short-term memory 313.

After obtaining the context information from short-term memory 313, the AI virtual assistant may submit one or more prompts to an LLM 316, 342 that includes the user request and at least a portion of the short-term context information and ask the LLM to determine whether the short-term context information is sufficient to handle the user request. If the LLM indicates that the provided short-term context information is sufficient, the method may proceed to block 650. Otherwise, the AI virtual assistant 314 may obtain additional context information from long-term memory.

In some examples, the AI virtual assistant 314 may invoke search functionality to obtain the additional context information from long-term memory. For example, the AI virtual assistant 314 may search a relevancy graph for other people or resources that are closely related to the user, such as other people with an edge connecting them to the user within the relevancy graph or within a threshold degrees of separation and with a threshold level of strength of connection to the user. For example, if the user is connected to another user by an edge, and the weight assigned to the edge is 0.8 (from 0 to 1), the search may return the other user as being strongly connected to the user. Similarly, if the user is indirectly connected to another user by an intervening user, the strength of the connections between the user and the other user may be used to determine if the two are sufficiently well-connected and should be returned by the search.

Iin some examples, the long-term memory 315 may also search the user's available information, such as calendar, chat channels, or email inbox to identify information relevant to the user request 302. For example, if the user references preparing for an upcoming meeting, the AI virtual assistant 314 may search the long-term memory for past meetings having similar subjects or similar groups of participants or chat channels discussing topics related to the upcoming meeting. Still other searches may be performed of the long-term memory to obtain additional long-term context information.

In some examples, the AI virtual assistant 314 may provide the short-term context information and the obtained long-term context information to the LLM to determine if sufficient context information has been obtained, similar to that discussed above with respect to the short-term context information discussed above. If the LLM indicates that sufficient context information has been obtained, the method may proceed to block 650. Otherwise, the AI assistant may perform additional searching of the long-term memory 315 or may request additional information from the user to assist with the request 302.

At block 650, the AI virtual assistant 314 will determine one or more services based on the user intent as discussed above with respect to FIGS. 3A-3B. For example, the AI virtual assistant may request that the LLM identify tasks and tasks orderings needed to perform the user request. The AI virtual assistant may then request that the LLM identify the services 380 to be invoked by providing the tasks and the description of available services to the LLM 316, 342.

At block 660, the AI virtual assistant 314 invokes the services 380 based on the identified tasks and services as well as the ordering of the tasks generally as discussed above with respect to FIGS. 3A-3B.

At block 670, the AI virtual assistant 314 generates and provides a response to the user request based on an output from the one or more services that were invoked. In some examples, only a single service was invoked, thus, the AI virtual assistant 314 may provide the output from that single service to the user. Though in some examples, it may perform post-processing on the output, such as providing it to the LLM 316, 342 to improve the output by prompting the LLM 316 to change the tone, formality, language, or other aspect of the output. If the multiple services 380 were invoked, the LLM 316, 342 may be provided with the outputs and prompted to generate a combined output based on the provided outputs. To do so, the LLM 316, 342 may be provided with the user request 302 and some or all of the context information received or obtained by the AI virtual assistant at blocks 630 and 640. For example, the LLM 316, 342 may be provided the following prompts:
Prompt 1: Please generate a complete response to the following request: [User request]
Prompt 2: Please use the following context information when generating the complete response: [Context information]
Prompt 3: Here is the information to use to generate the complete response: [Outputs from services]

In some examples, the prompts may also identify the specific tasks 362 that were originally identified by the LLM 316, 342 to assist the LLM 316, 342 in generating the response to the user request. The prompts to the LLM 316, 342 may also specify the format of the output, such as an email, a calendar invitation, a text file, a shared document at a cloud service provider, an audio or video file, or any other type of output suitable for the user request 302.

The output may be provided to the user via the GUI 400 or it may be provided to the user via a different mechanism, such as by providing a file to download, a link (e.g., a uniform resource locator) to the output, playing an audio or video file via the client device's speaker(s) or display device, or any other suitable output mechanism to provide the response to the user.

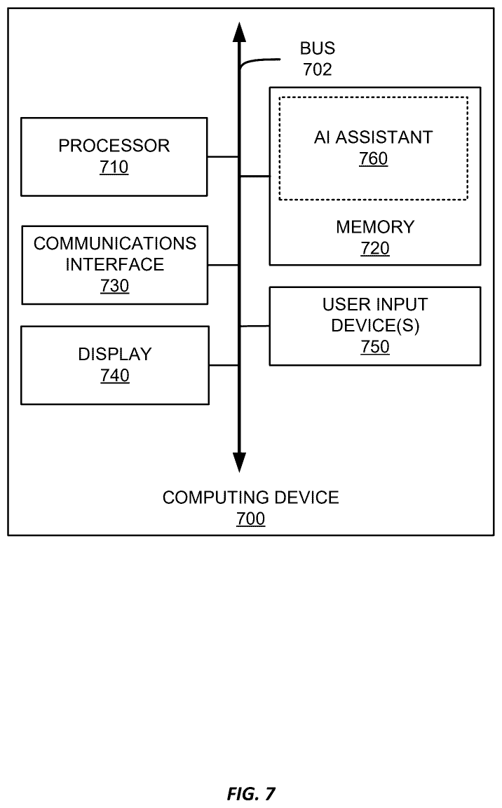

Referring now to FIG. 7, FIG. 7 shows an example computing device 700 suitable for use in example systems or methods for task processing and execution using LLMs according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for enhanced AI virtual assistants according to different examples, such as part or all of the example method 600 described above with respect to FIG. 6. Suitable example computing devices 700, such as user client devices, may also include one or more user input devices 750, such as a keyboard, mouse, touchscreen, microphone, etc., to accept user input. The computing device 700 also includes a display 740 to provide visual output to a user. In addition, the computing device 700 includes an AI assistant 760, such as discussed above with respect to FIGS. 3A-3B.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by an artificial intelligence (“AI”) assistant from client software executed by a client device associated with a user, a user request;
determining an intent based on the user request;
determining a user context or an operational context associated with the user request;
obtaining short-term context information based on the user request;
identifying one or more services based on the intent;
invoking the one or more services based on the user request, the operational context, and the obtained short-term context information; and
generating and providing a response to the user request based on an output from the one or more services.

2. The method of claim 1, wherein determining the operational context comprises determining one or more states of the client software.

3. The method of claim 2, wherein the one or more states of the client software comprise an identification of an active tab in the client software, an active chat channel in the client software, an active meeting in the client software, an active email message in the client software, a current time, or a source of the user request.

4. The method of claim 1, wherein determining the operational context comprises obtaining user information from a profile associated with the user.

5. The method of claim 1, wherein obtaining the short-term context information comprises obtaining communication information associated with the user, the communication information comprising information about one or more meetings, one or more email messages, or one or more chat channels.

6. The method of claim 1, wherein determining an intent based on the user request comprises generating a request embedding based on the user request, generating one or more service embeddings corresponding to one or more available services, and determining a relationship between the request embedding and the one or more service embeddings.

7. The method of claim 1, wherein determining an intent based on the user request comprises providing the user request to a large language model (“LLM”).

8. The method of claim 1, further comprising:
accessing a short-term memory comprising the short-term context information;
providing the user request and at least a subset of the short-term context information to a large language model (“LLM”);
receiving an indication that the at least the subset of the short-term context information is sufficient based on the user request;
and wherein the at least the subset of the short-term context information is the obtained context information.

9. The method of claim 1, further comprising:
accessing a short-term memory comprising the short-term context information;
providing the user request and at least a subset of the short-term context information to a large language model (“LLM”);
receiving an indication that the at least the subset of the short-term context information is not sufficient based on the user request;
accessing a long-term member comprising long-term context information;
providing the user request, the at least the subset of the short-term context information, and at least a subset of the long-term context information to a large language model (“LLM”);
receiving an indication that the at least the subset of the short-term context information and the at least the subset of the long-term context information is sufficient based on the user request; and
wherein the at least the subset of the short-term context information and the at least the subset of the long-term context information is the obtained short-term context information.

10. The method of claim 1, wherein generating the response comprises:
obtaining outputs from the one or more invoked services; and
providing, to a large-language model (“LLM”), one or more prompts to generate the response based on the user request, the operational context, the obtained short-term context information, and the outputs.

11. A system comprising:
a communications interface;
a non-transitory computer-readable medium; and
one or more processors configured to execute processor-executable instructions stored in the non-transitory computer-readable medium to:
receive, by an artificial intelligence (“AI”) assistant from client software executed by a client device associated with a user, a user request;
determine an intent based on the user request;
determine a user context or an operational context associated with the user request;
obtain short-term context information based on the user request;
identify one or more services based on the intent;
invoke the one or more services based on the user request, the operational context, and the obtained short-term context information; and
generate and provide a response to the user request based on an output from the one or more services.

12. The system of claim 11, wherein the one or more processors are configured to execute further processor-executable instructions stored in the non-transitory computer-readable medium to determine one or more states of the client software.

13. The system of claim 11, wherein the one or more processors are configured to execute further processor-executable instructions stored in the non-transitory computer-readable medium to obtain user information from a profile associated with the user.

14. The system of claim 11, wherein the one or more processors are configured to execute further processor-executable instructions stored in the non-transitory computer-readable medium to generate a request embedding based on the user request, generate one or more service embeddings corresponding to one or more available services, and determine a relationship between the request embedding and the one or more service embeddings.

15. The system of claim 11, wherein determining an intent based on the user request comprises providing the user request to a large language model (“LLM”).

16. The system of claim 11, wherein the one or more processors are configured to execute further processor-executable instructions stored in the non-transitory computer-readable medium to:
access a short-term memory comprising the short-term context information;
provide the user request and at least a subset of the short-term context information to a large language model (“LLM”);
receive an indication that the at least the subset of the short-term context information is sufficient based on the user request;
and wherein the at least the subset of the short-term context information is the obtained context information.

17. A non-transitory computer-readable medium comprising processor-executable instructions configured to cause one or more processors to:
receive, by an artificial intelligence (“AI”) assistant from client software executed by a client device associated with a user, a user request;
determine an intent based on the user request;
determine a user context or an operational context associated with the user request;
obtain short-term context information based on the user request;
identify one or more services based on the intent;
invoke the one or more services based on the user request, the operational context, and the obtained short-term context information; and
generate and provide a response to the user request based on an output from the one or more services.

18. The non-transitory computer-readable medium of claim 17, further comprising processor-executable instructions configured to cause the one or more processors to determine one or more states of the client software.

19. The non-transitory computer-readable medium of claim 17, further comprising processor-executable instructions configured to cause the one or more processors to obtain user information from a profile associated with the user.

20. The non-transitory computer-readable medium of claim 17, further comprising processor-executable instructions configured to cause the one or more processors to:
accessing a short-term memory comprising the short-term context information;
providing the user request and at least a subset of the short-term context information to a large language model (“LLM”);
receiving an indication that the at least the subset of the short-term context information is sufficient based on the user request;
and wherein the at least the subset of the short-term context information is the obtained context information.
